(19) United States
(12) Patent Application Publication
(10) Pub. No.: US 2023/0092147 A1
(43) Pub. Date: Mar. 23, 2023

(54) Neighborhood Distillation of Deep Neural Networks

(71) Applicant: Google LLC, Mountain View, CA (US)

(72) Inventors: Laëtitia Shao, Mountain View, CA (US); Elad Edwin Tzvi Eban, Sunnyvale, CA (US); Yair Alon, Mountain View, CA (US)

(21) Appl. No.: 17/801,455

(22) PCT Filed: Jun. 23, 2020
(86) PCT No.: PCT/US2020/039098

§ 371 Date: Aug. 22, 2022

(51) Int. Cl. G06N 3/04; G06N 3/08

(52) U.S. Cl. CPC G06N 3/0454; G06N 3/08

(57) ABSTRACT

Systems and methods for distilling deep neural networks are disclosed in which a teacher network is divided into blocks or “neighborhoods.” Candidate student models are then trained to reproduce the output of each teacher neighborhood, and the best student model corresponding to each neighborhood may be selected for inclusion in a final student network. In some examples, the final student network may be comprised of a collection of selected student models and copies of one or more teacher network neighborhoods.

### BACKGROUND

Knowledge distillation is a general model compression/optimization method that transfers the knowledge of a large teacher network (or set thereof) to a smaller student network, or from a network whose architecture is suited to run on one type of hardware to a network whose architecture is suited to run on a different type of hardware. However, in traditional end-to-end distillation, candidate student networks (which are usually a variant of the teacher network with a smaller number of layers and/or parameters, or with an architecture that is suited to a different type of hardware) must be individually trained to mimic the output of the teacher network, and then compared to one another in order to choose which student network is best in terms of complexity and/or accuracy. Because some layers or groups of layers in a deep neural network will be harder to distill than others, finding the ideal architecture for the student network can require consideration of a large number of candidate student networks, and thus can be both computationally expensive and time-consuming.

### BRIEF SUMMARY

The present technology relates to systems and methods for distilling deep neural networks. In that regard, the technology relates to distilling a teacher network into a student network by selecting blocks or “neighborhoods” of the teacher network, training individual student models to reproduce the output of each teacher neighborhood, selecting the best student model corresponding to each teacher neighborhood, and then assembling the student models to create a full student network.

In one aspect, the disclosure describes a method of using a first neural network to generate a second neural network, comprising: (i) dividing the first neural network into a plurality of neighborhoods; (ii) for each given neighborhood of the plurality of neighborhoods: generating, by one or more processors of a processing system, a plurality of candidate student models; receiving, by the one or more processors, a first output from the given neighborhood, the first output having been produced by the given neighborhood based on an input; receiving, by the one or more processors, a plurality of second outputs, each second output having been produced by a given candidate student model of the plurality of candidate student models based on the input; comparing, by the one or more processors, the first output to each second output of the plurality of second outputs to generate a first training gradient corresponding to each candidate student model of the plurality of candidate student models; modifying, by the one or more processors, one or more parameters of each given candidate student model of the plurality of candidate student models based at least in part on the first training gradient corresponding to the given candidate student model; and identifying, by the one or more processors, a selected model, the selected model being a copy of one of the plurality of candidate student models or a copy of the given neighborhood; and (iii) combining, by the one or more processors, the selected model corresponding to each given neighborhood of the plurality of neighborhoods to form the second neural network. In some aspects, identifying the selected model is based at least in part on a comparison of a size of each candidate student model of the plurality of candidate student models. In some aspects, identifying the selected model is based at least in part on a comparison of a number of layers of each candidate student model of the plurality of candidate student models. In some aspects, identifying the selected model is based at least in part on a comparison of a measurement of how closely each candidate student model of the plurality of candidate student models approximates the output of the given neighborhood. Further, in some aspects, the measurement of how closely each candidate student model of the plurality of candidate student models approximates the output of the given neighborhood is based at least in part on a mean square error between an output of the given neighborhood based on a given input and an output of each candidate student model of the plurality of candidate student models based on the given input. In some aspects, the input comprises an output received from a neighborhood preceding the given neighborhood.

In some aspects, the method set forth in the preceding paragraph further comprises, for each given neighborhood of the plurality of neighborhoods: providing, by the one or more processors, the first output to a head model, the head model comprising a copy of a portion of the first neural network which directly follows the given neighborhood; providing, by the one or more processors, each second output of the plurality of second outputs to the head model; receiving, by the one or more processors, a third output from a head model, the third output having been produced by the head model based on the first output; receiving, by the one or more processors, a plurality of fourth outputs, each fourth output having been produced by the head model based on a given second output of the plurality of second outputs; and comparing, by the one or more processors, the third output to each fourth output of the plurality of fourth outputs to generate a second training gradient corresponding to each candidate student model of the plurality of candidate student models; and modifying, by the one or more processors, the one or more parameters of each given candidate student model of the plurality of candidate student models based at least in part on the second training gradient corresponding to the given candidate student model. Further, in some aspects, identifying the selected model is based at least in part on a comparison of a measurement of how closely each candidate student model of the plurality of candidate student models approximates the output of the given neighborhood. Further still, in some aspects, the measurement of how closely each candidate student model of the plurality of candidate student models approximates the output of the given neighborhood is based at least in part on a mean square error between an output of the given neighborhood based on a given input and an output of each candidate student model of the plurality of candidate student models based on the given input. In some aspects, the input comprises an output received from a neighborhood preceding the given neighborhood.

In another aspect, the disclosure describes a processing system comprising: a memory; and one or more processors coupled to the memory and configured as follows. In that regard, for each given neighborhood of a plurality of neighborhoods, where each given neighborhood comprises a piece of a first neural network, the one or more processors are configured to: generate a plurality of candidate student models; receive a first output from the given neighborhood, the first output having been produced by the given neighborhood based on an input; receive a plurality of second outputs, each second output having been produced by a given candidate student model of the plurality of candidate student models based on the input; compare the first output to each second output of the plurality of second outputs to generate a first training gradient corresponding to each candidate student model of the plurality of candidate student models; modify one or more parameters of each given candidate student model of the plurality of candidate student models based at least in part on the first training gradient corresponding to the given candidate student model; and identify a selected model, the selected model being a copy of one of the plurality of candidate student models or a copy of the given neighborhood. In addition, the one or more processors are configured to combine the selected model corresponding to each given neighborhood of the plurality of neighborhoods to form a second neural network. In some aspects, the one or more processors are further configured to identify the selected model based at least in part on a comparison of a size of each candidate student model of the plurality of candidate student models. In some aspects, the one or more processors are further configured to identify the selected model based at least in part on a comparison of a number of layers of each candidate student model of the plurality of candidate student models. In some aspects, the one or more processors are further configured to identify the selected model based at least in part on a comparison of a measurement of how closely each candidate student model of the plurality of candidate student models approximates the output of the given neighborhood. Further, in some aspects, the measurement of how closely each candidate student model of the plurality of candidate student models approximates the output of the given neighborhood is based at least in part on a mean square error between an output of the given neighborhood based on a given input and an output of each candidate student model of the plurality of candidate student models based on the given input. In some aspects, the input comprises an output received from a neighborhood preceding the given neighborhood.

In some aspects, the one or more processors described in the preceding paragraph are further configured to, for each given neighborhood of the plurality of neighborhoods: provide the first output to a head model, the head model comprising a copy of a portion of the first neural network which directly follows the given neighborhood; provide each second output of the plurality of second outputs to the head model; receive a third output from the head model, the third output having been produced by the head model based on the first output; receive a plurality of fourth outputs, each fourth output having been produced by the head model based on a given second output from the plurality of second outputs; compare the third output to each fourth output of the plurality of fourth outputs to generate a second training gradient corresponding to each candidate student model of the plurality of candidate student models; and modify the one or more parameters of each given candidate student model of the plurality of candidate student models based at least in part on the second training gradient corresponding to the given candidate student model. Further, in some aspects, the one or more processors are further configured to identify the selected model based at least in part on a comparison of a measurement of how closely each candidate student model of the plurality of candidate student models approximates the output of the given neighborhood. Further still, in some aspects, the measurement of how closely each candidate student model of the plurality of candidate student models approximates the output of the given neighborhood is based at least in part on a mean square error between an output of the given neighborhood based on a given input and an output of each candidate student model of the plurality of candidate student models based on the given input. In some aspects, the input comprises an output received from a neighborhood preceding the given neighborhood.

### BRIEF DESCRIPTION OF THE DRAWINGS

FIG. 1 is a functional diagram of an example system in accordance with aspects of the disclosure.

FIG. 2 depicts an example process flow showing how a teacher network may be distilled into a student network according to aspects of the disclosure.

FIGS. 3A and 3B depict example process flows showing how a trainer may calculate mean square errors that can be used to create training gradients.

FIG. 4 is a flow diagram of an exemplary method of performing neighborhood distillation in accordance with aspects of the disclosure.

FIG. 5 is a flow diagram of an exemplary method of performing neighborhood distillation in accordance with aspects of the disclosure.

### DETAILED DESCRIPTION

The present technology will now be described with respect to the following exemplary systems and methods.

### Example Systems

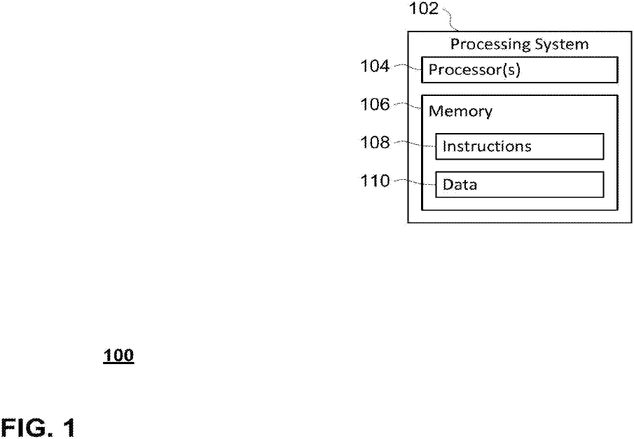

A high-level system diagram 100 in accordance with aspects of the technology is shown in FIG. 1. Processing system 102 includes one or more processors 104, and memory 106 storing instructions 108 and data 110. Instructions 108 and data 110 may include the teacher network, student models, and student network described herein. However, any of the teacher network, the student models, and/or the student network may also be maintained on one or more separate processing systems or storage devices to which the processing system 102 has access. This could include a cloud-computing system, in which case the processing system 102 may provide input to, receive output from, and make changes to the teacher network, student models, and/or student network via one or more networks (not shown) in order to perform the distillation methods described herein.

Processing system 102 may be implemented on any type of computing device(s), such as any type of general computing device, server, or set thereof, and may further include other components typically present in general purpose computing devices or servers. Memory 106 stores information accessible by the one or more processors 104, including instructions 108 and data 110 that may be executed or otherwise used by the processor(s) 104. Memory 106 may be of any non-transitory type capable of storing information accessible by the processor(s) 104. For instance, memory 106 may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, touch screen and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

The computing devices may comprise a speech recognition engine configured to convert a speech input by a user into a microphone associated with the computing device into text data. Such an input may be a user query directed towards, for example, an automated assistant accessible through the computing device. The text data generated from the user voice input may be processed using any of the methods described herein to tokenize the text data for further processing. The tokenized text data may, for example, be processed to extract a query for the automated assistant that is present in the user voice input. The query may be sent to the automated assistant, which may in turn provide one or more services to the user in response to the query via the computing device.

### Example Methods

The present technology provides methods and systems for breaking a teacher network down into smaller sub-networks, referred to herein as neighborhoods, which may each be distilled independently and then reassembled into a student network. Because each neighborhood is simpler than the teacher network, each candidate student model for a given neighborhood can be trained in parallel, significantly reducing the time necessary for training each candidate student model. This may also reduce the number of comparisons that need to be made in order to identify the optimal architecture for the student network. In that regard, using neighborhood distillation, if there are K different configurations tried for n different neighborhoods, the processing system must only train K x n candidate student models in order to identify the optimal combination of student models to include in the final student network. In contrast, using end-to-end distillation, the processing system would need to train every permutation, consisting of Kⁿ full candidate student networks, in order to find the same optimal final student network. Finally, if the neighborhoods are kept sufficiently small, it becomes possible to train each candidate student model using general CPUs rather than requiring the custom accelerators (e.g., TPUs) traditionally used for direct learning, and to feed the networks random Gaussian noise as an input rather than requiring data similar to what the teacher network was originally trained on.

The present technology may be used to generate a final student network that is simpler than the teacher network. Alternatively or additionally, the present technology may be used to generate a student network that is optimized to run on a particular hardware platform (e.g. a CPU, a mobile device, etc.) that is different from the hardware platform on which the teacher network was optimized to run (e.g. a TPU, a GPU, an enterprise server, etc.).

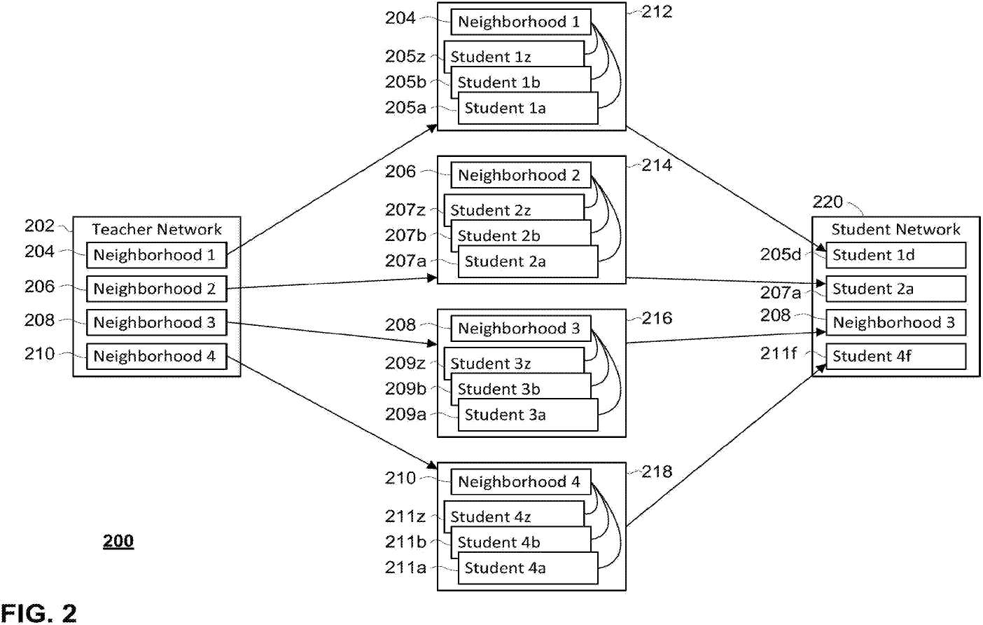

FIG. 2 depicts an example process flow 200 showing how a teacher network 202 may be distilled into a student network 220 according to aspects of the disclosure. In the example of FIG. 2, teacher network 202 is a deep neural network that has already been trained. Teacher network 202 may be any kind of neural network having multiple layers, blocks, units, elements, nodes, etc. For example, teacher network 202 may be a neural network with 100 layers that has been trained to classify image data. In the example of FIG. 2, teacher network 202 is broken down into four teacher network neighborhoods 204, 206, 208, and 210. This partitioning of the teacher network 202 may be done automatically (e.g., by dividing the teacher network into a predetermined number of neighborhoods, or into neighborhoods of a predetermined number of layers), or the neighborhoods may be selected by an operator. Neighborhoods will each include a separate, non-overlapping piece of the teacher network, but do not need to be the same size as each other or comprise the same number of layers, blocks, units, elements, nodes, etc. Thus, for example, the teacher network could be broken up unequally, such that teacher network neighborhood 204 comprises layers 1-20 of teacher network 202, teacher network neighborhood 206 comprises layers 21-60 of teacher network 202, teacher network neighborhood 208 comprises layers 61-70 of teacher network 202, and teacher network neighborhood 210 comprises layers 71-100 of teacher network 202. Likewise, the teacher network could be broken up equally, such that teacher network neighborhood 204 could comprise layers 1-25 of teacher network 202, teacher network neighborhood 206 comprises layers 26-50 of teacher network 202, teacher network neighborhood 208 comprises layers 51-75 of teacher network 202, and teacher network neighborhood 210 comprises layers 76-100. In addition, not all layers of the teacher network 202 must be assigned to a neighborhood. Rather, in some cases, various layers of the teacher network 202 may be fixed, so that no attempt is made to distill them, and those layers are included unchanged in the student network 220. In such cases, the set of neighborhoods 204, 206, 208, and 210 would represent a subset of all layers in teacher network 202.

In the example of FIG. 2, each teacher network neighborhood 204, 206, 208, and 210 (or a copy thereof) is used by a separate trainer 212, 214, 216, and 218, respectively, to train a set of individual candidate student models. This training, described in further detail below, involves a recursive process of feeding a set of data to the teacher network neighborhood and each candidate student model, and tuning the parameters of each candidate student model (using training gradients and back-propagation) until the output of each candidate student model begins to approximate (or match) the output of the teacher network neighborhood for each input. This process may utilize some or all of the original dataset on which the teacher network 202 was trained (e.g., a set of images, or set of text documents), a set of data similar to the dataset on which the teacher network 202 was trained (e.g., a different set of images, or a different set of text documents), Gaussian noise, or some combination thereof.

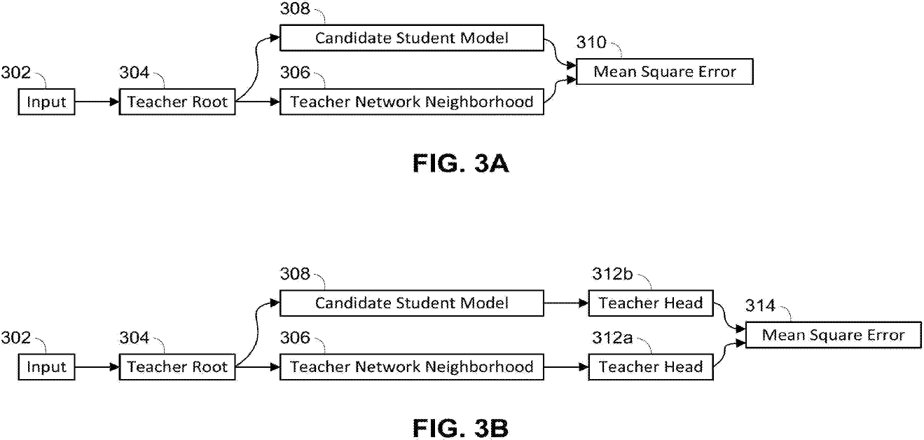

Trainers 212, 214, 216, and 218 may be any set of processes running serially or in parallel on processing system 102, or on a set of processing systems. As shown in FIG. 2, trainer 212 compares neighborhood 204 (or a copy thereof) to a set of candidate student models 205a-205z, and chooses a candidate student model 205d for inclusion in student network 220. Likewise, trainer 214 compares neighborhood 206 (or a copy thereof) to a set of candidate student models 207a-207z, and chooses candidate student model 207a for inclusion in student network 220. In contrast, trainer 216 compares neighborhood 208 (or a copy thereof) to a set of candidate student models 209a-209z, but ultimately chooses to include a copy of neighborhood 208 in student network 220. Finally, trainer 218 compares neighborhood 210 (or a copy thereof) to a set of candidate student models 211a-211z, and chooses candidate student model 211f for inclusion in student network 220. In each case, the input vectors received by each candidate student model are constrained to have the same dimension as the vector that is received by their respective teacher network neighborhood, and the output vectors produced by each candidate student model are likewise constrained to have the same dimension as the vector that is produced by their respective teacher network neighborhood. This ensures that the teacher network neighborhood and each candidate student model can be trained using the same inputs, and that their outputs can be compared as described below with respect to FIGS. 3A and 3B. This also allows the eventual student network 220 to be comprised of a collection of student models and teacher network neighborhoods as shown in the example of FIG. 2.

While the example of FIG. 2 uses a set of 26 candidate student models for each teacher network neighborhood labeled “a” through “z,” the present technology is not limited to any particular number of candidate student models. In that regard, any suitable number of candidate student models may be used. Likewise, a different number of candidate student models may be assessed for one teacher network neighborhood than for another.

The selections shown in FIG. 2 are also for exemplary purposes only. In that regard, student network 220 may consist entirely of individual candidate student models, or may include two or more of the original teacher network neighborhoods. In addition, in cases where various layers of the teacher network 202 are fixed and no attempt is made to distill them (as discussed above), the selected models (student model 205d, student model 207a, neighborhood 208, and student model 211f) may be joined together with the fixed layers of the teacher network 202 in order to create student network 220.

Trainers 212, 214, 216, and 218 may be configured to assess candidate student models and make their selections based on any suitable criteria. For example, the trainers may be configured to select the simplest or smallest candidate student model (e.g., the candidate student model with the fewest layers and/or parameters) that meets a certain threshold accuracy when compared to its respective teacher network neighborhood (e.g., accuracy within x% of the teacher network neighborhood, calculated using an average mean square error over some predetermined number of outputs). Further in that regard, in some aspects of the technology, the accuracy of the candidate student model may be assessed by assembling it with one or more preceding or trailing teacher network neighborhoods to form an intermediate model. Thus, for example, the accuracy of student model 209b may be assessed by creating a first intermediate model comprised of neighborhood 204, neighborhood 206, and student model 209b, and comparing its performance to a second intermediate model comprised of neighborhood 204, neighborhood 206, and neighborhood 208. In such a case, inputs may be passed into neighborhood 204 of the first and second intermediate models, and the resulting outputs from student model 209b and neighborhood 208 may then be compared.

Likewise, the trainers may be configured to select the most accurate candidate student model that falls below a threshold size or simplicity (e.g., a size less than or equal to y% of the teacher network neighborhood, or a size with less than z layers or parameters). In addition, while the selected candidate student models may in some cases be simpler or smaller than their respective teacher network neighborhoods, they need not be in all cases. For example, in instances where the teacher network is optimized for inference to take place on one type of platform (e.g., a TPU or enterprise server) and is being distilled in order to create a student network that can be used by a different hardware platform (e.g., a PC or mobile device), the selected student models (or the student network as a whole) may ultimately be as complex or more complex than their respective teacher network neighborhoods (or the teacher network as a whole) but still be desirable due to their compatibility.

In addition, as shown with respect to trainer 216, a trainer may also be configured to choose not to replace a given teacher network neighborhood with one of the candidate student models, and to instead simply include a copy of the given teacher network neighborhood in the student network. The trainer may be configured to do this, for example, where none of the candidate student models are found to mimic the output of the teacher network neighborhood with acceptable accuracy, or where none of the acceptably accurate candidate student models are found to be acceptably small and/or simple relative to the given teacher network neighborhood.

In some aspects of the technology, the trainers may be configured to train each candidate student model with the goal of minimizing a loss function measuring a difference between the output of the teacher network and the output of the candidate student model. For example, the trainers may be configured to train each candidate student model by minimizing the mean square error between its output and the output of the teacher network neighborhood. In that regard, FIGS. 3A and 3B show two ways in which the trainer may calculate mean square errors that can be used to create training gradients. A trainer may be configured to use only the method of FIG. 3A, only the method of FIG. 3B, or may use the methods of FIGS. 3A and 3B together to train the candidate student model to mimic the output of the teacher network neighborhood.

In the example of FIG. 3A, a teacher network is broken into two portions: a teacher network neighborhood 306; and a teacher root 304. The teacher root 304 is a portion of the teacher network that immediately precedes the teacher network neighborhood 306. The teacher root 304 may be comprised of one or more contiguous layers, blocks, units, elements, nodes, etc., but must include whatever layer, block, unit, element, node, etc. that passes output to the first layer, block, unit, element, node, etc. of the teacher network neighborhood 306. The trainer will then conduct training by passing an input 302 into the teacher root 304, which will pass output to both the teacher network neighborhood 306 and the candidate student model 308.

In the example of FIG. 3A, in order to enable the teacher root 304’s output to be passed to the candidate student model 308, the candidate student model 308 is configured to accept a vector of the same dimension as that which the teacher network neighborhood 306 is configured to accept. The teacher network neighborhood 306 and the candidate student model 308 will then both generate outputs based on the inputs they received from the teacher root 304. The outputs from the teacher network neighborhood 306 and the candidate student model 308 are then compared to create a mean square error 310. Mean square error 310 represents an objective loss between the candidate student model and the teacher network neighborhood, and may be used by the trainer to recursively generate training gradients and tune the parameters of the candidate student model until the objective loss between the output of the candidate student model 308 and the output of the teacher network neighborhood 306 has been minimized. While a mean square error 310 calculation is used in the example of FIG. 3A, it will be appreciated that other loss functions may alternatively be used. In some aspects of the technology, the outputs from the teacher root 304 for each input 302 may be pre-computed and stored before training so that those outputs may be fed directly into the candidate student model 308 and teacher network neighborhood 306. Likewise, in some aspects of the technology, the outputs from the teacher network neighborhood 306 for each input 302 may be pre-computed and stored before training so that only the output of the candidate student model 308 must be computed prior to calculating each mean square error 310.

In the example of FIG. 3B, a teacher network is broken into three portions: a teacher network neighborhood 306; a teacher root 304; and a teacher head 312a. The teacher root 304 is the same as in FIG. 3A, and thus is a portion of the teacher network that immediately precedes the teacher network neighborhood 306. Again, the teacher root 304 may be comprised of one or more contiguous layers, blocks, units, elements, nodes, etc., but must include whatever layer, block, unit, element, node, etc. that passes output to the first layer, block, unit, element, node, etc. of the teacher network neighborhood 306. Similarly, the teacher head 312a is a portion of the teacher network that immediately follows the teacher network neighborhood 306. As such, the teacher head 312a may be comprised of one or more contiguous layers, blocks, units, elements, nodes, etc., but must include whatever layer, block, unit, element, node, etc. that receives output from the last layer, block, unit, element, node, etc. of the teacher network neighborhood 306. The trainer will then conduct training by passing an input 302 into the teacher root 304, which will pass output to both the teacher network neighborhood 306 and the candidate student model 308. Here again, in order to enable the teacher root 304’s output to be passed to the candidate student model 308, the candidate student model 308 is configured to accept a vector of the same dimension as that which the teacher network neighborhood 306 is configured to accept.

Based on the signal passed to them by the teacher root 304, the teacher network neighborhood 306 and the candidate student model 308 will both generate outputs. In that regard, in the example of FIG. 3B, the teacher network neighborhood 306 will pass its output to the teacher head 312a, while the candidate student model 308 will pass its output to teacher head 312b, which is an identical copy of teacher head 312a. In some aspects of the technology, this identical copy of the teacher head may not be used, and the candidate student model 308 may instead pass its output to teacher head 312a before or after teacher network neighborhood 306 passes its output to teacher head 312a.

In the example of FIG. 3B, in order to enable the candidate student model 308’s output to be passed to the teacher head 312b, the vector output of the candidate student model 308 is configured to be the same dimension as that of the teacher network neighborhood 306. Teacher head 312a and teacher head 312b will then generate outputs based on what they receive from the teacher network neighborhood 306 and candidate student model 308, respectively. Those outputs from teacher head 312a and teacher head 312b will be compared to create a mean square error 314. Mean square error 314 represents a look-ahead loss between the candidate student model and the teacher network neighborhood. Here as well, while a mean square error 314 calculation is used in the example of FIG. 3B, it will be appreciated that other loss functions may alternatively be used.

As explained above, mean square error 314 may also be used by the trainer, alone or in combination with mean square error 310, to recursively generate training gradients and tune the parameters of the candidate student model until the look-ahead loss has been minimized. Here as well, in some aspects of the technology, the output from the teacher root 304 for each input may be pre-computed and stored before training so that those outputs may be fed directly into the candidate student model 308 and teacher network neighborhood 306. Likewise, in some aspects of the technology, the outputs from the teacher head 312a based on the signals received from teacher network neighborhood 306 (which in turn are based on each each input 302) may be pre-computed and stored before training so that only the output of teacher head 312b (i.e., the teacher head’s output based on what is received from the candidate student model 308) must be computed prior to calculating each mean square error 314.

In some aspects of the technology, after a full student model 220 has been generated as described above with respect to FIG. 2, it may be further distilled using neighborhood distillation. In such cases, the student network 220 will become a new teacher network, and will be broken down into further neighborhoods (which need not correspond to the individual student models from which it was composed) in order to create a new student network. This may be done, for example, in order to distill an existing student network which is optimized for one hardware platform into a new student network optimized for another hardware platform.

In addition, in some aspects of the technology, after a full student model 220 has been generated as described above with respect to FIG. 2, it may be further fine-tuned using the original dataset on which the teacher network 202 was trained (e.g., a set of images, or set of text documents), or a set of data similar to the dataset on which the teacher network 202 was trained (e.g., a different set of images, or a different set of text documents). In some instances, this may improve the final accuracy of the student network 220 relative to the teacher network 202.

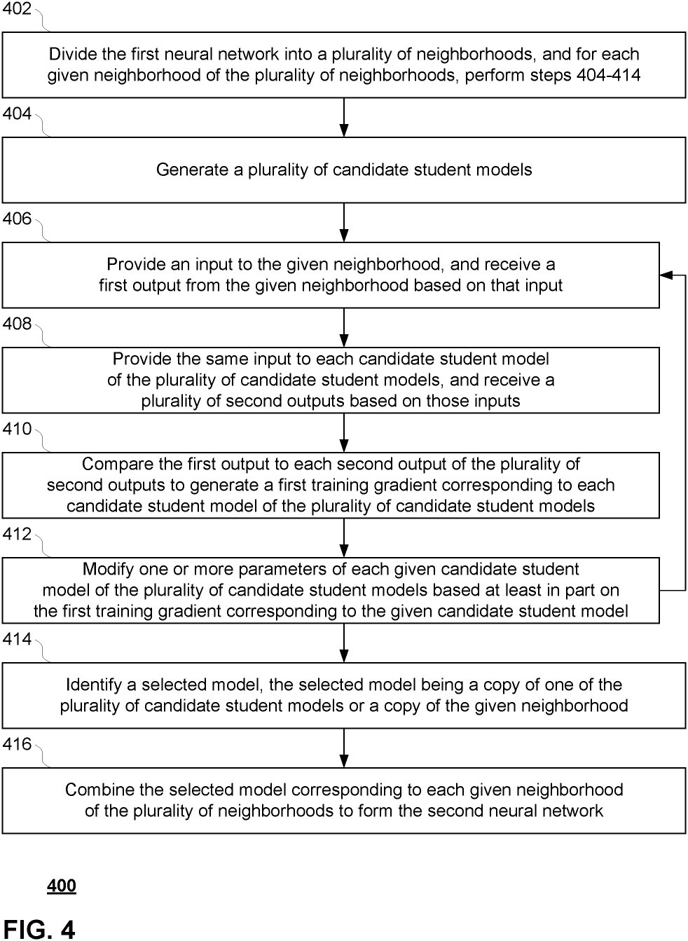

FIG. 4 is a flow diagram of an exemplary method 400 of performing neighborhood distillation in accordance with aspects of the disclosure. In that regard, in step 402, a first neural network (e.g., teacher network 202 of FIG. 2) is divided into a plurality of neighborhoods (e.g., neighborhoods 204, 206, 208, 210 of FIG. 2). This division of the first neural network may be done manually or by processing system 102, as already described. Then, for each given neighborhood of the plurality of neighborhoods, the processing system 102 will perform steps 404-414. In that regard, the processing system 102 may process each given neighborhood (according to steps 404-414) in parallel or in series.

In step 404, the processing system 102 generates a plurality of candidate student models for each given neighborhood. For example, in the context of FIG. 2, for given neighborhood 204, the processing system 102 will generate student models 205a-z. This step will also be performed for each additional given neighborhood, resulting in processing system 102 generating student models 207a-z for neighborhood 206, student models 209a-z for neighborhood 208, and student models 211a-z for neighborhood 210.

In step 406, the processing system 102 provides an input to each given neighborhood, and receives a first output from the given neighborhood based on that input. For example, in the context of FIG. 2, the processing system 102 will provide an input to given neighborhood 204 and receive a first output from given neighborhood 204 based on that input. Again, this step will also be performed for each additional given neighborhood of the plurality of neighborhoods.

Likewise, in step 408, the processing system 102 provides the same input to each candidate student model of the plurality of candidate student models, and receives a plurality of second outputs based on those inputs. Thus, continuing with the example of FIG. 2, using the same input provided (or to be provided) to given neighborhood 204, the processing system 102 will provide that input to each of student models 205a-z, and will receive a separate “second output” from each of student models 205a-z based on that input. Here as well, this step will also be performed for the student models associated with each additional given neighborhood of the plurality of neighborhoods.

Then, in step 410, for each given neighborhood, the processing system 102 compares the first output (received in step 406) to each second output of the plurality of second outputs (received in step 408) to generate a first training gradient corresponding to each candidate student model of the plurality of candidate student models. These “first training gradients” may be generated, for example, as described above with respect to FIG. 3A. Thus, continuing with the example of FIG. 2, for given neighborhood 204, the processing system 102 will compare the first output received from neighborhood 204 to each of the second outputs received from each of student models 205a-z, and will generate a first training gradient for each of student models 205a-z. Here as well, this step will also be performed for each additional given neighborhood of the plurality of neighborhoods to create first training gradients for each of their respective student models.

Next, in step 412, for each given neighborhood, the processing system 102 modifies one or more parameters of each given candidate student model of the plurality of candidate student models based at least in part on the first training gradient corresponding to the given candidate student model. Moreover, as indicated by the arrow extending from step 412 back to step 406, once these parameters have been modified, steps 406-412 may be repeated so as to recursively feed new inputs to the given neighborhood and each candidate student model and tune the parameters of each candidate student model (based on newly generated training gradients) until the output of each candidate student model begins to approximate (or match) the output of the given neighborhood for each input. Here as well, the recursive subprocess of steps 406-412 may utilize some or all of the original dataset on which the first neural network was trained (e.g., a set of images, or set of text documents), a set of data similar to the dataset on which the teacher network 202 was trained (e.g., a different set of images, or a different set of text documents), Gaussian noise, or some combination thereof. Thus, continuing with the example of FIG. 2, for given neighborhood 204, the processing system 102 will modify one or more parameters of each of student models 205a-z, and then may repeat steps 406-412 using a new input and these modified parameters for student models 205a-z. Likewise, these steps will also be performed for each additional given neighborhood of the plurality of neighborhoods so as to recursively tune the parameters of their respective student models.

Following the recursive subprocess of steps 406-412, the processing system 102 identifies, for each given neighborhood, a selected model. The selected model may be a copy of one of the plurality of candidate student models, or it may be a copy of the given neighborhood (e.g., in cases where none of the candidate student models is deemed acceptable). As discussed above with respect to FIG. 2, the processing system 102 may make these selections based on any suitable criteria, such as by choosing the simplest or smallest candidate student model that meets a certain threshold accuracy when compared to its respective given neighborhood, or by choosing the most accurate candidate student model that falls below a threshold size or level of simplicity. Thus, continuing with the example of FIG. 2, the processing system 102 will identify student model 205d as the selected model corresponding to neighborhood 204, will identify student model 207a as the selected model corresponding to neighborhood 206, will identify teacher network neighborhood 208 itself as the selected model corresponding to neighborhood 208, and will identify student model 4f as the selected model corresponding to neighborhood 210.

Finally, in step 416, the processing system 102 combines the selected model corresponding to each given neighborhood of the plurality of neighborhoods to form the second neural network. Thus, continuing with the example of FIG. 2, the processing system 102 will combine each selected model (student model 205d, student model 207a, teacher network neighborhood 208, and student model 211f) to form the final student network 220. Here as well, in some cases, the second neural network may also include copies of one or more fixed pieces of the first network that were not allocated to one of the neighborhoods, and thus not processed according to the steps of method 400.

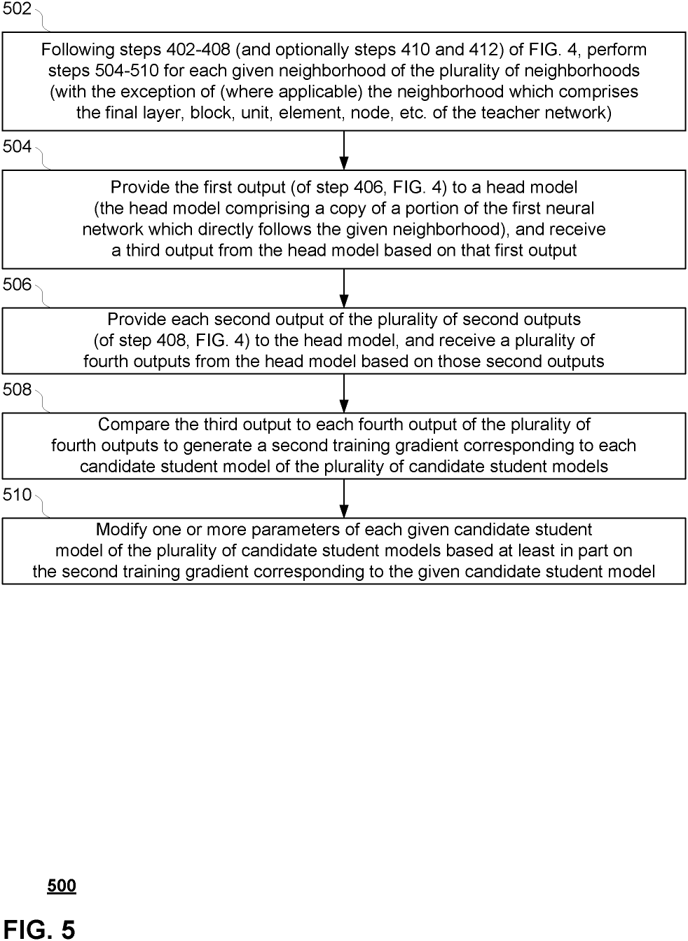

FIG. 5 is a flow diagram of an exemplary method 500 of performing neighborhood distillation in accordance with aspects of the disclosure. As set forth in step 502, method 500 sets forth steps that may take place in addition to the steps of method 400 of FIG. 4. Specifically, after the first network has been divided into a plurality of neighborhoods (step 402), and a first output and a plurality of second outputs are generated for a given neighborhood (steps 404-408), the processing system 102 may additionally perform steps 504-510 of FIG. 5 for each given neighborhood of the plurality of neighborhoods, with the exception of (where applicable) the neighborhood that comprises the final layer, block, unit, element, node, etc. of the teacher network.

In that regard, in step 504, the processing system 102 provides the first output (received from each given neighborhood in step 406 of FIG. 4) to a head model, and receives a third output from the head model based on that first output. The head model comprises a copy of a portion of the first neural network which directly follows the given neighborhood, as described more fully above with respect to teacher head 312a of FIG. 3B. Thus, continuing with the example of FIG. 2, for given neighborhood 204, the processing system 102 will provide the output it receives from given neighborhood 204 to neighborhood 206 (or some piece thereof) in order to obtain a “third output” from neighborhood 206 (or such piece thereof). This step will also be performed for each additional given neighborhood of the plurality of neighborhoods. However, where one of the plurality of neighborhoods comprises the final layer, block, unit, element, node, etc. of the teacher network, there will be no way to create a head model for that neighborhood, and thus steps 504-510 will not be undertaken for that neighborhood (as noted in step 502). Rather, for a neighborhood that comprises the final layer, block, unit, element, node, etc. of the teacher network, the processing system 102 may instead be configured to only generate a first training gradient for that neighborhood as described above with respect to steps 406-412 of FIG. 4.

Likewise, in step 506, the processing system 102 provides each second output of the plurality of second outputs (received from each candidate student model in step 408 of FIG. 4) to the head model, and receives a plurality of fourth outputs from the head model based on those second outputs. Thus, continuing with the example of FIG. 2, for given neighborhood 204, the processing system 102 will provide the output it receives from each of student models 205a-z to neighborhood 206 (or some piece thereof) in order to obtain a plurality of “fourth outputs” from neighborhood 206 (or such piece thereof). Here as well, this step will also be performed for the student models associated with each additional given neighborhood of the plurality of neighborhoods, with the exception of (where applicable) the neighborhood that comprises the final layer, block, unit, element, node, etc. of the teacher network for which no head model will exist.

In step 508, for each given neighborhood, the processing system 102 compares the third output (received in step 504) to each fourth output of the plurality of fourth outputs (received in step 506) to generate a second training gradient corresponding to each candidate student model of the plurality of candidate student models. These second training gradients may be generated, for example, as described above with respect to FIG. 3B. Thus, continuing with the example of FIG. 2, for given neighborhood 204, the processing system 102 will compare the third output received from neighborhood 206 (based on the first output received from neighborhood 204) to each fourth output received from neighborhood 206 (each of which is based on a second output received from a different one of the student models 205a-z), in order to generate a second training gradient for each of student models 205a-z. Here as well, this step will also be performed for each additional given neighborhood of the plurality of neighborhoods to create training gradients for their respective student models, with the exception of (where applicable) the neighborhood that comprises the final layer, block, unit, element, node, etc. of the teacher network for which no head model will exist.

Finally, in step 510, for each given neighborhood, the processing system 102 modifies one or more parameters of each given candidate student model of the plurality of candidate student models based at least in part on the second training gradient (generated in step 508) corresponding to the given candidate student model. In that regard, as method 500 is performed in addition to method 400 of FIG. 4, steps 504-510 may be repeated as a part of the recursive process described above with respect to steps 406-412. Thus, once these parameters have been modified as set forth in step 510, steps 406-412 of FIG. 4 and steps 504-510 of FIG. 5 may be repeated so as to recursively feed new data to the given neighborhood and each candidate student model, and thus tune the parameters of each candidate student model (based on newly generated first and second training gradients) until the output of each candidate student model begins to approximate (or match) the output of the given neighborhood for each input. Here as well, the recursive subprocess of steps 406-412 of FIG. 4 and steps 504-510 of FIG. 5 may utilize some or all of the original dataset on which the first neural network was trained (e.g., a set of images, or set of text documents), a set of data similar to the dataset on which the teacher network 202 was trained (e.g., a different set of images, or a different set of text documents), Gaussian noise, or some combination thereof. Thus, continuing with the example of FIG. 2, for given neighborhood 204, the processing system 102 will additionally modify one or more parameters of each of student models 205a-z based on the second training gradient (in addition to doing so based on the first training gradient as set forth in step 412), and then may repeat steps 406-412 of FIG. 4 and steps 504-510 of FIG. 5 using a new input and these modified parameters for student models 205a-z. Likewise, these steps will also be performed for each additional given neighborhood of the plurality of neighborhoods to modify the parameters of their respective student models and recursively tune them.

Further, in some aspects of the technology, steps 410 and 412 may be omitted from the combined methods of FIGS. 4 and 5 (except with respect to (where applicable) the neighborhood that comprises the final layer, block, unit, element, node, etc. of the teacher network, as described above). In that regard, after steps 404-408 are performed for a given neighborhood, steps 504-510 may be performed (as described above) such that the only training gradients generated would be the “second training gradients” generated in step 508, and such that the candidate student models would be modified based on those “second training gradients” as described in step 510. Following the modification in step 510, steps 406-408 of FIG. 4 and steps 504-510 of FIG. 5 may then be repeated as already described so as to recursively feed new data to the given neighborhood and each candidate student model, and thus tune the parameters of each candidate student model (based on newly generated second training gradients) until the output of each candidate student model begins to approximate (or match) the output of the given neighborhood for each input.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A method of using a first neural network to generate a second neural network, comprising:
dividing the first neural network into a plurality of neighborhoods;
for each given neighborhood of the plurality of neighborhoods:
generating, by one or more processors of a processing system, a plurality of candidate student models;
receiving, by the one or more processors, a first output from the given neighborhood, the first output having been produced by the given neighborhood based on an input;
receiving, by the one or more processors, a plurality of second outputs, each second output having been produced by a given candidate student model of the plurality of candidate student models based on the input;
comparing, by the one or more processors, the first output to each second output of the plurality of second outputs to generate a first training gradient corresponding to each candidate student model of the plurality of candidate student models;
modifying, by the one or more processors, one or more parameters of each given candidate student model of the plurality of candidate student models based at least in part on the first training gradient corresponding to the given candidate student model; and
identifying, by the one or more processors, a selected model, the selected model being a copy of one of the plurality of candidate student models or a copy of the given neighborhood; and
combining, by the one or more processors, the selected model corresponding to each given neighborhood of the plurality of neighborhoods to form the second neural network.

2. The method of claim 1, wherein identifying the selected model is based at least in part on a comparison of a size of each candidate student model of the plurality of candidate student models.

3. The method of claim 1, wherein identifying the selected model is based at least in part on a comparison of a number of layers of each candidate student model of the plurality of candidate student models.

4. The method of claim 1, wherein identifying the selected model is based at least in part on a comparison of a measurement of how closely each candidate student model of the plurality of candidate student models approximates the output of the given neighborhood.

5. The method of claim 4, wherein the measurement of how closely each candidate student model of the plurality of candidate student models approximates the output of the given neighborhood is based at least in part on a mean square error between an output of the given neighborhood based on a given input and an output of each candidate student model of the plurality of candidate student models based on the given input.

6. The method of claim 1, wherein the input comprises an output received from a neighborhood preceding the given neighborhood.

7. The method of claim 1, further comprising:
for each given neighborhood of the plurality of neighborhoods:
providing, by the one or more processors, the first output to a head model, the head model comprising a copy of a portion of the first neural network which directly follows the given neighborhood;
providing, by the one or more processors, each second output of the plurality of second outputs to the head model;
receiving, by the one or more processors, a third output from a head model, the third output having been produced by the head model based on the first output;
receiving, by the one or more processors, a plurality of fourth outputs, each fourth output having been produced by the head model based on a given second output of the plurality of second outputs; and
comparing, by the one or more processors, the third output to each fourth output of the plurality of fourth outputs to generate a second training gradient corresponding to each candidate student model of the plurality of candidate student models; and
modifying, by the one or more processors, the one or more parameters of each given candidate student model of the plurality of candidate student models based at least in part on the second training gradient corresponding to the given candidate student model.

8. The method of claim 7, wherein identifying the selected model is based at least in part on a comparison of a measurement of how closely each candidate student model of the plurality of candidate student models approximates the output of the given neighborhood.

9. The method of claim 8, wherein the measurement of how closely each candidate student model of the plurality of candidate student models approximates the output of the given neighborhood is based at least in part on a mean square error between an output of the given neighborhood based on a given input and an output of each candidate student model of the plurality of candidate student models based on the given input.

10. The method of claim 7, wherein the input comprises an output received from a neighborhood preceding the given neighborhood.

11. A processing system comprising:
a memory; and
one or more processors coupled to the memory and configured to:
for each given neighborhood of a plurality of neighborhoods, each given neighborhood comprising a piece of a first neural network:
generate a plurality of candidate student models;
receive a first output from the given neighborhood, the first output having been produced by the given neighborhood based on an input;
receive a plurality of second outputs, each second output having been produced by a given candidate student model of the plurality of candidate student models based on the input;
compare the first output to each second output of the plurality of second outputs to generate a first training gradient corresponding to each candidate student model of the plurality of candidate student models;
modify one or more parameters of each given candidate student model of the plurality of candidate student models based at least in part on the first training gradient corresponding to the given candidate student model; and
identify a selected model, the selected model being a copy of one of the plurality of candidate student models or a copy of the given neighborhood; and
combine the selected model corresponding to each given neighborhood of the plurality of neighborhoods to form a second neural network.

12. The system of claim 11, wherein the one or more processors are further configured to identify the selected model based at least in part on a comparison of a size of each candidate student model of the plurality of candidate student models.

13. The system of claim 11, wherein the one or more processors are further configured to identify the selected model based at least in part on a comparison of a number of layers of each candidate student model of the plurality of candidate student models.

14. The system of claim 11, wherein the one or more processors are further configured to identify the selected model based at least in part on a comparison of a measurement of how closely each candidate student model of the plurality of candidate student models approximates the output of the given neighborhood.

15. The system of claim 14, wherein the measurement of how closely each candidate student model of the plurality of candidate student models approximates the output of the given neighborhood is based at least in part on a mean square error between an output of the given neighborhood based on a given input and an output of each candidate student model of the plurality of candidate student models based on the given input.

16. The system of claim 11, wherein the input comprises an output received from a neighborhood preceding the given neighborhood.

17. The system of claim 11, wherein the one or more processors are further configured to:
for each given neighborhood of the plurality of neighborhoods:
provide the first output to a head model, the head model comprising a copy of a portion of the first neural network which directly follows the given neighborhood;
provide each second output of the plurality of second outputs to the head model;
receive a third output from the head model, the third output having been produced by the head model based on the first output;
receive a plurality of fourth outputs, each fourth output having been produced by the head model based on a given second output from the plurality of second outputs;
compare the third output to each fourth output of the plurality of fourth outputs to generate a second training gradient corresponding to each candidate student model of the plurality of candidate student models; and
modify the one or more parameters of each given candidate student model of the plurality of candidate student models based at least in part on the second training gradient corresponding to the given candidate student model.

18. The system of claim 17, wherein the one or more processors are further configured to identify the selected model based at least in part on a comparison of a measurement of how closely each candidate student model of the plurality of candidate student models approximates the output of the given neighborhood.

19. The system of claim 18, wherein the measurement of how closely each candidate student model of the plurality of candidate student models approximates the output of the given neighborhood is based at least in part on a mean square error between an output of the given neighborhood based on a given input and an output of each candidate student model of the plurality of candidate student models based on the given input.

20. The system of claim 17, wherein the input comprises an output received from a neighborhood preceding the given neighborhood.
